(19) United States
(12) Patent Application Publication
(10) Pub. No.: US 2016/0173526 A1
(43) Pub. Date: Jun. 16, 2016

(54) Method and System for Protecting Against Distributed Denial of Service Attacks

(71) Applicant: NXLabs Limited

(72) Inventors: Juniman KASMAN, Hong Kong (HK); Ming feng HUANG, Hong Kong (HK); Xiao hai LU, Hong Kong (HK); Ying Qiang XU, Hong Kong (HK); Yu GUO, Hong Kong (HK); Ryan CHIN, Hong Kong (HK)

(21) Appl. No.: 14/565,440

(22) Filed: Dec. 10, 2014

(51) Int. Cl. H04L 29/06

(52) U.S. Cl. CPC H04L 63/1458

(57) ABSTRACT

A DDoS attack mitigation process, comprising: receiving a request from a client device; computing a data access frequency for the client device, data access frequency being a number of requests received from the client device within a set period of time; comparing the data access frequency to a threshold value, wherein a

DDoS attack is suspected if the data access frequency is higher than the threshold value; if a DDoS attack is not suspected, then the request being forwarded to the intended resource; else if a DDoS attack is suspected, then responding to the client user's device with a DDoS attack mitigation challenge webpage embedded with a user-interactive widget to the client user's device requiring the client device's user to drag a prompt icon along a movement path without interrupt for authentication.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The present invention relates generally to systems and methods of protecting against distributed denial of service (DDoS) attacks in computing, electronic, mobile, and data communication networks. More particularly, the present invention relates to the use of Completely Automated Public Turing Test To tell

Computers and Humans Apart (CAPTCHA) and the like in protecting against DDoS attacks on Internet web sites and other network resources.

### BACKGROUND

A distributed denial of service (DDoS) attack is an attempt to make a computer server device or network resource unavailable to its intended users. A common form of DDoS attack is to use one or more computing devices running self-executing computer instructions (generally referred to as “bots”) to repeatedly send bogus data communication messages in heavy volume to a targeted computer server device or network resource. These bogus data communication messages often are to request for services from the targeted computer server device or network resource. The goal is to saturate the network bandwidth or computing capacity of the targeted computer server device or network resource in its attempt to provide the services requested in respond to the bogus data communication messages.

To defend a computer server device or network resource against DDoS attacks, in general the first task is to distinguish the bogus data communication messages from genuine legitimate data communication messages received. There are mainly two types of DDoS attack mitigation for this first task: 1.) user-transparent mitigation that causes no visual impact to and requires no interaction from a legitimate user of computing device or network resource, such as HTTP redirect which artificially redirects under the HTTP 302 protocol, webpage snippet insertion, and artificial webpage loading waits that discriminate only legitimate user's browser software application and not bots; and 2.) user-interactive mitigation that requires authenticating or acknowledgement action from the user, such as CAPTCHA.

However, there are serious shortcomings in both types of DDoS attack mitigation. For instance, under the user-interactive mitigation schemes, if the required user action is designed to be simple, then it can be easily circumvented by bots; otherwise if the required user action is designed to be complex, then it can become user unfriendly. Another shortcoming is that the traditional DDoS attack mitigations are designed to work primarily with desktop or laptop computers running conventional Internet browser software applications.

With the rise of use of mobile communication devices, such as “smartphones” and tablet personal computers, computer server devices and network resources are increasing in need to be configured to communicate with these mobile communication devices running specifically designed mobile software applications (generally referred to as “apps”). Many mobile apps do not necessary conform to the Internet standard protocols such as HTTP and HTML, or understand the popular Internet scripting languages such as JavaScript, DHTML, and Ajax. Although some of these mobile apps are mobile versions of the conventional Internet browser software applications, due to the much smaller physical form factors and different user input interfaces of these mobile communication devices, traditional user interface designs, including those of existing DDoS attack mitigations, are poorly fit for these mobile versions Internet browser software applications. As such these DDoS attack mitigations perform poorly, if not entirely unsuitable, for computer server devices and network resources configured to communicate and interact with mobile apps.

### SUMMARY

It is an objective of the presently claimed invention to provide a method and system for protecting against DDoS attacks that can be used for computer server devices and network resources configured to communicate and interact with desktop or laptop computers running conventional Internet browser software applications as well as mobile communication devices running mobile versions of Internet browser software applications. It is a further objective of the presently claimed invention to provide such method and system that incorporate an user-interactive type mitigation that is suitable for the various user interfaces of desktop or laptop computers as well as mobile communication devices with user friendly design.

In accordance with one aspect of the present invention, a DDoS attack mitigation system is provided and is implemented by a central processing server configured to execute machine instructions. The machine instructions can be logically grouped into functional modules: a reverse proxy traffic handler, a detection filter, a configuration updater module, and a policy database.

In accordance with another aspect of the present invention, a DDoS attack mitigation process is provided, comprising: receiving a request for a service or access to a resource from a client user's device, wherein the service or resource being hosted in a second computer processor; computing a data access frequency for the client user's device, wherein data access frequency being a number of requests received from the client user's device within a set period of time; comparing the data access frequency to a threshold value, wherein a DDoS attack is detected if the data access frequency is higher than the threshold value; if a DDoS attack is not detected, then the request being forwarded to the second computer processor to be processed by the service or resource access requested; else if a DDoS attack is detected, then responding to the client user's device with a DDoS attack mitigation challenge webpage embedded with a user-interactive widget to the client user's device, wherein the user-interactive widget requiring a user of the client user's device to perform a user action of either using a mouse or a finger to drag a prompt icon along a movement path without interrupt; if a DDoS attack is detected and the user completes the user action, then the client user's device is considered authenticated and the request is forwarded to the second computer processor to be processed by the service or resource access requested; else the client user's device continues to be responded with the DDoS attack mitigation challenge webpage.

### BRIEF DESCRIPTION OF THE DRAWINGS

Embodiments of the invention are described in more detail hereinafter with reference to the drawings, in which

FIG. 1 shows a block diagram illustrating an exemplary embodiment of a computing environment that the presently claimed DDoS mitigation system is applicable;

FIG. 2 shows a logical diagram illustrating the logical functional modules of the DDoS mitigation system in accordance to one embodiment of the present invention;

FIG. 3 shows a screen capture of a DDoS attack mitigation challenge webpage widget in accordance to one embodiment of the present invention;

FIG. 4 shows a screen capture of a DDoS attack mitigation challenge webpage widget in accordance to another embodiment of the present invention; and

FIG. 5 shows a logical diagram illustrating the process steps and data flow of the DDoS mitigation process in accordance to one embodiment of the present invention.

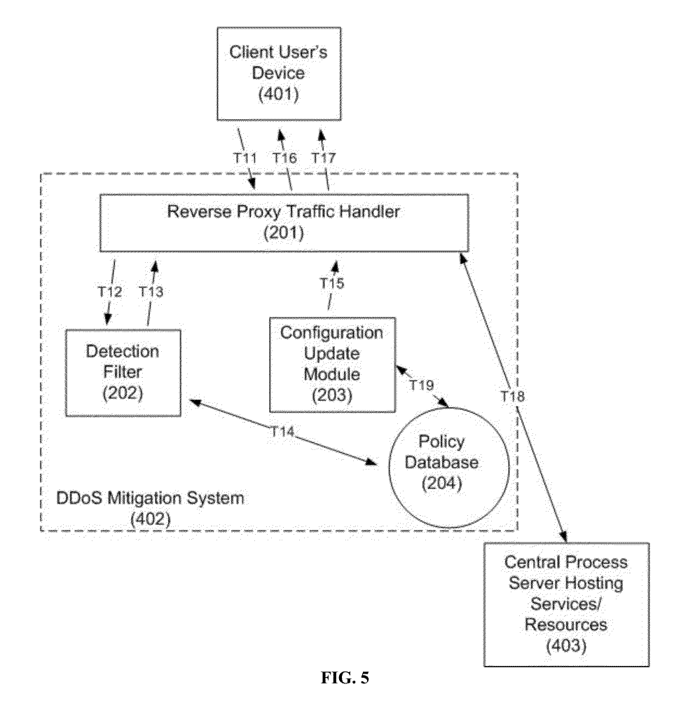

### DETAILED DESCRIPTION

In the following description, methods and systems for protecting against DDoS attacks and the like are set forth as preferred examples. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

System:

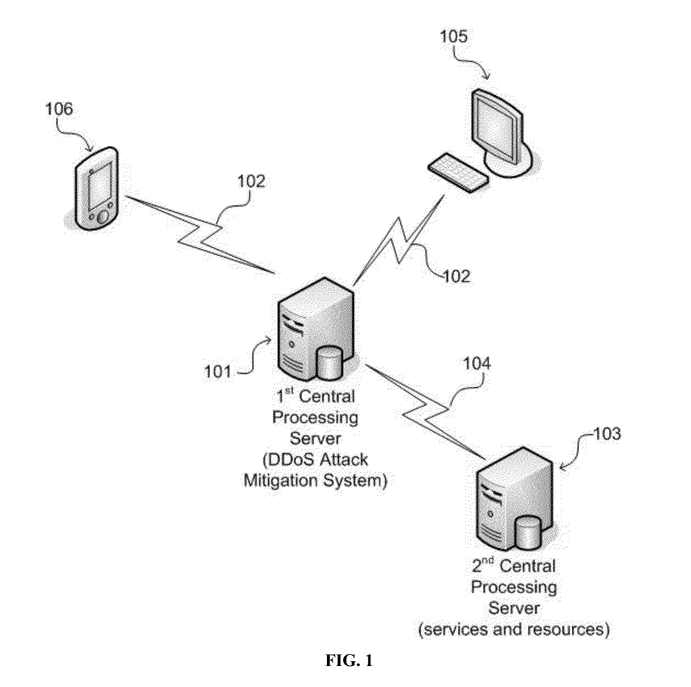

Referring to FIG. 1. In accordance with various embodiments, the presently claimed invention is applicable in a computing environment comprising: a first central processing server (or a first cluster of multiple processing servers) 101 accessible through a first communication network 102, which can be the Internet, a telecommunication network, or any network supporting the TCP/IP protocol; a second central processing server (or a second cluster of multiple processing servers) 103 connected to the first central processing server 101 through a second communication network 104, wherein the second communication network 104 can be the same as the first communication network 102; a plurality of client users using various devices including desktop and laptop computers 105 running conventional Internet browser software applications to access the services provided by the second central processing server 103, and mobile communication devices 106 running mobile versions of

Internet browser software applications to access the services and/or resources (e.g. an URL) provided by the second central processing server 103.

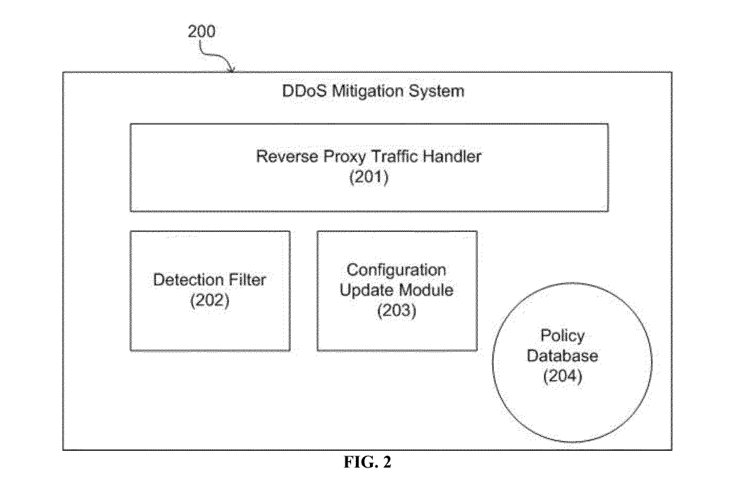

Referring to FIG. 2. In accordance with one aspect, the first central processing server (or cluster of multiple processing servers) 101 is configured to execute machine instructions implementing the presently claimed DDoS attack mitigation system. The machine instructions can be logically grouped into functional modules. The functional modules are: reverse proxy traffic handler 201, detection filter 202, configuration updater module 203, and policy database 204.

The reverse proxy traffic handler 201 acts as an intermediary between the client users' devices 105 and 106, and the services and/or resources provided by the second central processing server (or cluster of multiple processing servers) 103 in their data communication paths. The reverse proxy traffic handler 201 includes the functionalities of a reverse proxy server as commonly known in the art, and it is implementable by any means known by an ordinarily skilled person in the art. The reverse proxy traffic handler 201 is to intercept the data traffic to the second central processing server (or cluster of multiple processing servers) 103 such as HTTP requests for services and/or resources originated from a client user's device, forward the HTTP requests to the second central processing server (or cluster of multiple processing servers) 103 if deemed safe and return the HTTP responds from the second central processing server (or cluster of multiple processing servers) 103 to the request data-originating client users' device. Otherwise if the data traffic is deemed unsafe, a mitigation is triggered and the reverse proxy traffic handler 201 HTTP-responds with a DDoS attack mitigation challenge to the data-originating client users' device.

In one embodiment, the reverse proxy traffic handler 201 is configured to maintain a list of IP addresses of legitimate and authenticated (or verified) client users' devices (trusted list) such that data traffic originating from a client user's device with an IP address that can be found in these lists will be deemed safe. The list of IP addresses can be stored in the policy database 204 and be loaded into the reverse proxy traffic handler 201 during configuration, on system user's demand, before or during runtime. In another embodiment, the reverse proxy traffic handler 201 is configured to maintain a list of IP addresses of known and suspected attackers, and unauthenticated (or unverified) client users' devices (untrusted list) such that data traffic originating from a client user's device with an IP address that can be found in these lists will be deemed unsafe. The list of IP addresses can be stored in the policy database 204 and be loaded into the reverse proxy traffic handler 201 during configuration, on system user's demand, before or during runtime.

In one embodiment, the reverse proxy traffic handler 201 is configured to maintain a list of legitimate and available services and resources such that data traffic destined for a service or resource that can be found in these lists will be deemed safe. The list of legitimate and available services and resources can be stored in the policy database 204 and be loaded into the reverse proxy traffic handler 201 during configuration, on system user's demand, before or during runtime.

The reverse proxy traffic handler 201 also continuously records and computes the statistics on the data traffic it presently and previously intercepts and feed these statistics to the detection filter 202 for processing. The statistics include a data access frequency originated from every client users' device, the Internet Protocol (IP) address of every data-originating client users' device, and the particular services and/or resources being requested/accessed by every data-originating client users' device. The data access frequency is the number of individual data message received from a data-originating client users' device within a set period of time. It can be measured in the unit of transaction per second (tps).

The detection filter 202 uses the statistics on the data traffic generated by the reverse proxy traffic handler 201 and the policy data retrieved from the policy database 204 to determine whether a DDoS attack is underway for the data traffic from a data-originating client users' device. The policy data includes a list of previously recorded IP addresses of legitimate and authenticated (or verified) client users' devices (trusted list), a list of previously recorded IP addresses of known and suspected attackers, and unauthenticated (or unverified) client users' devices (untrusted list), a blocking threshold value of data access frequency above which a DDoS attack is considered detected, and a triggering threshold value of data access frequency above which a DDoS attack is considered suspected. In another embodiment, there can be a separate threshold value for each service or resource provided by the second central processing server (or cluster of multiple processing servers) 103. The one or more threshold values of data access frequency are system user configurable, stored in the policy database 204, retrieved and loaded into the detection filter 202 during configuration, on system user's demand, before or during runtime. The detection filter 202 can also update its trusted list and untrusted list it maintains during runtime.

The configuration updater module 203 receives configuration update requests from the policy database 204 to update the configuration of the reverse proxy traffic handler 201 including the list of IP addresses of legitimate and authenticated (or verified) client users' devices (trusted list), or the lists of IP addresses of known and suspected attackers, and unauthenticated (or unverified) client users' devices (untrusted list). The policy database 204 sends a configuration update request to the configuration updater module 203 to retrieve the policy data when there is a policy data change. The configuration updater module 203 then pushes the retrieved policy data to the reverse proxy traffic handler 201 to update its configuration. A policy data change can be a change in the trusted list, the untrusted list, or the list of legitimate and available services and resources.

In one embodiment where there is a plurality of DDoS attack mitigation systems running in the computing environment, one of the configuration updater modules can be dedicated to be the sole active configuration updater module for receiving configuration update requests from one or more policy database, retrieving the policy data, and pushing the policy data to all reverse proxy traffic handlers.

The policy database 204 stores data records of the one or more lists of IP addresses of legitimate and authenticated (or verified) client users' devices, the one or more lists of IP addresses of known and suspected attackers, and unauthenticated (or unverified) client users' devices, the one or more lists of legitimate and available services and resources, one or threshold values of data access frequency, and other system configuration and meta data. The database can be implemented using various commercially available relational database management systems such as Oracle® Database, Microsoft® SQL Server, and MySQL, and/or NoSQL databases such as MongoDB.

Each of the functional modules: reverse proxy traffic handler 201, detection filter 202, configuration updater module 203, and policy database 204, can be implemented and executed in a single physical computer server of the first central processing server 101, separately or in any combination in multiple physical computer servers of the cluster of multiple first central processing server 101.

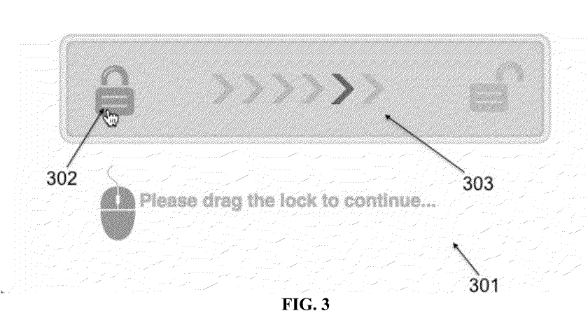

Referring to FIG. 3. In accordance with another aspect, the DDoS attack mitigation challenge HTTP-responded to a data-originating client users' device when its data traffic is deemed suspected to be a DDoS attack is a webpage (for conventional Internet browser software applications running in desktop and laptop computers) embedded with a user-interactive widget 301 and an associated snippet. In order to satisfy the mitigation challenge (authenticate), a user authentication action is required. The user authentication action is: using a pointing device, such as a computer mouse or a computer touchpad; first, move the pointing device pointer to rest on the prompt icon 302; then, press and hold a pointing device button and drag the prompt icon 302 in the direction along the movement path 303 to its full length before releasing the pointing device button and without interrupt. A person ordinarily skilled in the art will appreciate that the graphical representation, size, and orientation of the user-interactive widget 301 can be varied without deviating from the underlying concept. Once the mouse action is completed, the snippet detects the pointing device action completion and sends a HTTP request indicating a successful authentication to the first central processing server (or cluster of multiple processing servers) 101, or more precisely the reverse proxy traffic handler 201. Upon receiving the HTTP request indicating a successful authentication, the reverse proxy traffic handler 201 recognizes and records the IP address of the data-originating client users' device as an legitimate and authenticated (or verified), updates the corresponding lists it maintains, and responds to the client users' device with a redirect to the service or resource it intended to request or access.

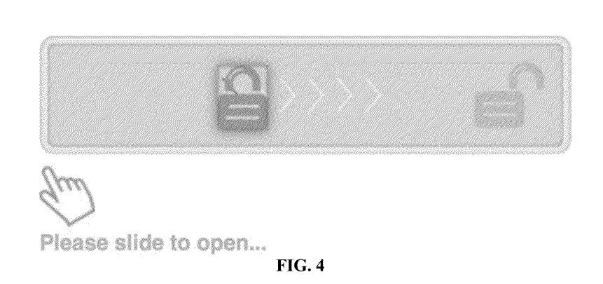

Referring to FIG. 4. In accordance with another embodiment, the DDoS attack mitigation challenge webpage is adapted for mobile communication devices running mobile versions of the Internet browser software applications. In this embodiment, the user-interactive widget 401 is substantially the same as the one for conventional Internet browser software applications running in desktop and laptop computers except that it replaces pointing device movement inputs with finger movement across touch screen inputs and mouse button press inputs with finger tap on touch screen inputs in dragging the prompt icon along the movement path.

DDoS Mitigation Process:

In accordance with various embodiments, the presently claimed invention includes a DDoS mitigation process executed by a DDoS mitigation system, the DDoS mitigation process comprising the following process steps:

1.) A client user's device 401 running an Internet browser software application requesting for a service or access to a resource (e.g. a URL), in turn generating a HTTP request T11 to a service or resource hosted in central processing server 403.

2.) The reverse proxy traffic handler 201 of the DDoS mitigation system 402 intercepts the HTTP request, examines the HTTP request, checks with a list of legitimate and available services and resources it maintains, determines if the HTTP request T11 is for one of the legitimate and available services and resources; and if so, establishes a TCP connection with the client user's device 401; otherwise, the DDoS mitigation system HTTP-responds to the client user's device 401 with a request/access denial or error message T2.

3.) The reverse proxy traffic handler 201 records the presently intercepted HTTP request and computes a data access frequency based on the presently and previously recorded HTTP requests from the client user's device 401 identified by its IP address. The reverse proxy traffic handler 201 then generates statistics that include the data access frequency originated from the client users' device 401, the IP address of the client users' device 401, and the particular services and/or resources being requested/accessed by the client users' device 401. The data access frequency is the number of HTTP requests received from the client users' device 401 within a set period of time. It can be measured in the unit of transaction per second (tps).

4.) The reverse proxy traffic handler 201 sends the statistics in a data message exchange T12 to the detection filter 202 of the DDoS mitigation system 402.

5.) The detection filter 202 retrieves the policy data from the policy database 204 in a data message exchange T14 and uses the statistics and the policy data to determine whether a DDoS attack is underway for the HTTP request from the client users' device. The policy data can include a list of IP addresses of legitimate and authenticated (or verified) client users' devices (trusted list), an untrusted list of IP addresses of known and suspected attackers, and unauthenticated (or unverified) client users' devices (untrusted list), a list of legitimate and available services and resources, a pre-defined blocking threshold value of data access frequency above which a DDoS attack is considered detected, a pre-defined triggering threshold value of data access frequency above which a DDoS attack is considered suspected, which is lower than the blocking threshold value, and a pre-defined retry limit for consecutive failed DDoS attack mitigation user authentication.

The detection filter 202 determines whether a DDoS attack is underway based on four conditions:

a.) The client users' device 401 has already been authenticated, as such the IP address of client users' device 401 is within the trusted list maintained by the detection filter 202. In this case, no DDoS attack is detected or suspected.
b.) The client users' device 401 has not yet been authenticated, as such the IP address of client users' device 401 is not within the trusted list maintained by the detection filter 202, but the data access frequency is still within the triggering threshold value. In this case, no DDoS attack is detected or suspected.
c.) The IP address of the client users' device 401 is not within the trusted list or the untrusted list maintained by the detection filter 202, and the data access frequency is above the triggering threshold value but still within the blocking threshold value. In this case, a DDoS attack is suspected.
d.) The IP address of the client users' device 401 is within the untrusted lists maintained by the detection filter 202, the data access frequency is above the blocking threshold value, or the user of the client users' device 401 has consecutively failed to authenticate the DDoS attack mitigation challenge a number of times above the retry limit. In this case, a DDoS attack is detected, and the client users' device 401 is denied access to the intended service or resource.

6.) If no DDoS attack is detected, the detection filter 202 sends a data message T13 to the reverse proxy traffic handler 201 to instruct it to forward the HTTP request from the client users' device 401 via data message exchanges T18 to the intended service or resource without mitigation and responds to the client users' device 401 with HTTP-responds T16.

7.) Otherwise, if a DDoS attack is suspected, the detection filter 202 sends a data message T13 to the reverse proxy traffic handler 201 to instruct it to start mitigation—sending a HTTP respond T17 to the client users' device 401 to display a DDoS attack mitigation challenge webpage embedded with a user-interactive widget and an associated snippet.

8.) If the user of the client user's device 401 acts to complete the user authentication action on DDoS attack mitigation challenge webpage, its snippet sends another HTTP request T11 indicating successful authentication to the detection filter 202, the reverse proxy traffic handler 201 forwards the HTTP request from the client users' device 401 via data message exchanges T18 to the intended service or resource and responds to the client users' device 401 with HTTP-responds T16. The detection filter 202 updates its trusted list with the inclusion of the IP address of the client users' device 401. The detection filter 202 can also update, via the message exchanges T14, the policy data in the policy database 204 with its updated trusted list.

9.) Otherwise, if the user of the client user's device 401 does not complete the user authentication action on DDoS attack mitigation challenge webpage, its snippet sends another HTTP request T11 indicating unsuccessful authentication to the detection filter 202, the reverse proxy traffic handler 201 responds to the client users' device 401 with HTTP-respond T17 to return the client users' device 401 to the DDoS attack mitigation challenge webpage. If the user of the client users' device 401 consecutively fails to authenticate the DDoS attack mitigation challenge within the number of times of the retry limit, a DDoS attack is detected and the client users' device 401 is denied access to the intended service or resource. The detection filter 202 updates its untrusted list with the inclusion of the IP address of the client users' device 401. The detection filter 202 can also update, via the message exchanges T14, the policy data in the policy database 204 with its updated untrusted list.

10.) The configuration updater module 203 runs as a background process and can, at anytime, receive configuration update requests from the policy database 204 to update the configuration of the reverse proxy traffic handler 201 including the one or more lists of IP addresses of legitimate and authenticated (or verified) client users' devices (trusted lists), or the one or more lists of IP addresses of known and suspected attackers, and unauthenticated (or unverified) client users' devices (untrusted lists). The policy database 204 sends a configuration update request to the configuration updater module 203 to retrieve the policy data when there is a policy data change via the data message exchanges T19. The configuration updater module 203 then pushes the retrieved policy data to the reverse proxy traffic handler 201 to update its configuration via the data message exchanges T15. A policy data change can be a change in the one or more trusted lists, the one or more untrusted lists, or the one or more lists of legitimate and available services and resources.

The embodiments disclosed herein may be implemented using general purpose or specialized computing devices, mobile communication devices, computer processors, or electronic circuitries including but not limited to digital signal processors (DSP), application specific integrated circuits (ASIC), field programmable gate arrays (FPGA), and other programmable logic devices configured or programmed according to the teachings of the present disclosure. Computer instructions or software codes running in the general purpose or specialized computing devices, mobile communication devices, computer processors, or programmable logic devices can readily be prepared by practitioners skilled in the software or electronic art based on the teachings of the present disclosure.

In some embodiments, the present invention includes computer storage media having computer instructions or software codes stored therein which can be used to program computers or microprocessors to perform any of the processes of the present invention. The storage media can include, but are not limited to, floppy disks, optical discs, Blu-ray Disc, DVD, CD-ROMs, and magneto-optical disks, ROMs, RAMs, flash memory devices, or any type of media or devices suitable for storing instructions, codes, and/or data.

Exemplary embodiments of mobile communication devices include, but are not limited to, mobile telephones, mobile telephones with personal computer like capability (commonly referred to as “smartphones”), electronic personal digital assistants (PDAs), portable computers with wired or wireless wide-area-network and/or telecommunication capability such as tablet personal computers and “netbook” personal computers.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

What is claimed is:

1. A computer implemented method for mitigating distributed denial of service (DDoS) attacks, comprising:
executing, by a first computer processor, a DDoS attack mitigation process, wherein the DDoS attack mitigation process comprises:
receiving a request for a service or access to a resource from a client user's device, wherein the service or resource being hosted in a second computer processor;
computing a data access frequency for the client user's device and comparing the data access frequency to a blocking threshold value and a triggering threshold value, wherein data access frequency being a number of requests received from the client user's device within a set period of time;
the client user's device's network address is checked against a trusted list of network addresses of legitimate and authenticated client users' devices;
if the client user's device's network address is within the trusted list, a DDoS attack is not detected or suspected;
else if the data access frequency is lower than the triggering threshold value, a DDoS attack is not detected or suspected;
else if the client user's device's network address is not within the trusted list and the data access frequency is equal or higher than the triggering threshold value, a DDoS attack is suspected;
else if the data access frequency is equal or higher than the blocking threshold value, a DDoS attack is detected;
if a DDoS attack is not detected or suspected, then the request being forwarded to the second computer processor to be processed by the service or resource access requested;
else if a DDoS attack is suspected, then responding to the client user's device with a DDoS attack mitigation challenge webpage embedded with a user-interactive widget requiring a user authentication action to be completed by a user of the client user's device;
if a DDoS attack is suspected and the user completes the user authentication action, then the client user's device is considered authenticated and the request is forwarded to the second computer processor to be processed by the service or resource access requested; else the client user's device continues to be responded with the DDoS attack mitigation challenge webpage;
if a DDoS attack is detected, the request being blocked from the second computer processor.

2. The method of claim 1, wherein the user authentication action being dragging of a prompt icon along a movement path to its full length without interrupt.

3. The method of claim 2, wherein the dragging of the prompt icon along the movement path without interrupt is performed by using a pointing device.

4. The method of claim 2, wherein the dragging of the prompt icon along the movement path without interrupt is performed by using finger movements on a touch screen device.

5. The method of claim 1, wherein the DDoS attack mitigation process further comprises:
after receiving the request for the service or access to the resource from the client user's device, the client user's device's network address is checked against an untrusted list of network addresses of known and suspected attackers, and unauthenticated client users' devices, and if the client user's device's network address is within the untrusted list, a DDoS attack is detected.

6. The method of claim 1, wherein the DDoS attack mitigation process further comprises:
if the user of the client users' device consecutively fails to complete the user authentication action within a number of times of a retry limit, a DDoS attack is detected.

7. The method of claim 6, wherein the DDoS attack mitigation process further comprises:
if the user of the client users' device consecutively fails to complete the user authentication action within a number of times of a retry limit, the client users' device's network address is added to the untrusted list.

8. The method of claim 1, wherein the DDoS attack mitigation process further comprises:
if the user of the client users' device completes the user authentication action within a number of times of a retry limit, a DDoS attack is not detected or suspected and the client users' device's network address is added to the trusted list.
